(19) United States
(12) Patent Application Publication
(10) Pub. No.: US 2011/0032075 A1
(43) Pub. Date: Feb. 10, 2011

(54) METHODS AND APPARATUS FOR HOME-TO-VEHICLE APPLICATIONS OVER WIRELESS LINKS

(75) Inventors: ANSAF I. ALRABADY, LIVONIA, MI (US); CALVIN E. WOLF, STERLING HEIGHTS, MI (US); FRED W. HUNTZICKER, ANN ARBOR, MI (US); DAVID T. PROEFKE, MADISON HEIGHTS, MI (US); SALVATORE G. TRUPIANO, TROY, MI (US)

Correspondence Address: INGRASSIA FISHER & LORENZ, P.C. (GM), 7010 E. COCHISE ROAD, SCOTTSDALE, AZ, 85253, US

(73) Assignees: GM GLOBAL TECHNOLOGY OPERATIONS, INC., DETROIT, MI (US); GENERAL MOTORS COMPANY, DETROIT, MI (US)

(21) Appl. No.: 12/537,847

(22) Filed: Aug. 7, 2009

(51) Int. Cl. G08C 17/02; G05B 19/00; G06F 7/04

(52) U.S. Cl. 340/5.72; 340/825; 340/5.8

(57) ABSTRACT

Methods and apparatus are provided for enabling communication between an information handling device, such as a computer, and a vehicle. A dongle is provided for enabling the communication and includes an external coupling device, dongle transceiver circuitry, and a dongle controller. The dongle transceiver circuitry enables remote keyless entry communication between the dongle and the vehicle. The external coupling device couples the dongle to the information handling device, and the dongle controller is coupled to the external coupling device for determining when the dongle is coupled to the information handling device. The dongle controller is also coupled to the dongle transceiver circuitry for providing a remote keyless entry wakeup message to the dongle transceiver circuitry in response to receiving a communication initiation signal from the information handling device.

### TECHNICAL FIELD

The present invention generally relates to wireless communication, and more particularly relates to methods and apparatus for establishing a wireless interface for home-to-vehicle applications.

### BACKGROUND OF THE INVENTION

Many vehicles today include wireless transceiving functionality utilizing a wireless link such as a radio frequency (RF) link. Such functionality can be useful for a vehicle owner to personalize vehicle functions employing home-to-vehicle applications. For example, media such as digital audio data can be downloaded to and/or updated at a vehicle by a user to allow replay of personalized audio playlists via a vehicle's audio system. Also, navigational data could be downloaded to or transmitted from a computer or other information handling device at the user's home or other wireless access point to the vehicle. A vehicle which includes such wireless transceiving functionality can establish local area wireless communication with a wireless access point at, for example, a user's home. However, it is problematic for a user to establish communication from the wireless access point to the vehicle. When the vehicle's ignition is OFF, the vehicle's local area wireless transceiver circuitry is unpowered in order to conserve the vehicle's battery power. While a user could start the vehicle each time communication is desired, such a solution is unwieldy. Further, even if a remote wakeup scheme is defined, requiring a user to wakeup the vehicle is also cumbersome.

Accordingly, it is desirable to provide a method and apparatus for reliably establishing a wireless link for home-to-vehicle applications which is transparent to a computer user at a home access point and wakes up vehicle transceiver circuitry without requiring starting the vehicle. Furthermore, other desirable features and characteristics of the present invention will become apparent from the subsequent detailed description and the appended claims, taken in conjunction with the accompanying drawings and the foregoing technical field and background.

### SUMMARY OF THE INVENTION

A method is provided for enabling communication between an information handling device and a vehicle. The method includes the steps of launching a local area communication application for communicating information between the information handling device and the vehicle via a predetermined local area wireless link and providing a communication initiation signal to a dongle connected to the information handling device for signaling the vehicle to establish the predetermined local area wireless link with the information handling device. The method further includes the step of, thereafter, communicating with the vehicle in response to the vehicle establishing the predetermined local area wireless link.

In addition, a dongle is provided for enabling communication between a vehicle and an information handling device. The dongle includes an external coupling device, dongle transceiver circuitry, and a dongle controller. The external coupling device couples the dongle to the information handling device. The dongle transceiver circuitry enables remote keyless entry communication between the dongle and the vehicle. The dongle controller is coupled to the external coupling device for determining when the dongle is coupled to the information handling device and is coupled to the dongle transceiver circuitry for providing a remote keyless entry wakeup message to the dongle transceiver circuitry in response to receiving a communication initiation signal from the information handling device.

Further, a communication system in a vehicle is provided for communicating with an information handling device at a wireless access point. The system includes first wireless transceiver circuitry, second wireless transceiver circuitry and a communication controller. The first wireless transceiver circuitry communicates with the information handling device via a predetermined local area wireless link. The second wireless transceiver circuitry communicates with a dongle via a remote keyless entry communication link. The communication controller is coupled to the first and second wireless transceiver circuitries and activates the first wireless transceiver circuitry for communicating via the predetermined local area wireless link with the information handling device at the wireless access point in response to detecting reception of a remote keyless entry wakeup message received by the second wireless transceiver circuitry.

### DESCRIPTION OF THE DRAWINGS

The present invention will hereinafter be described in conjunction with the following drawing figures, wherein like numerals denote like elements, and

FIG. 1 illustrates a diagram of a communication system in accordance with an embodiment of the present invention;

FIG. 2 illustrates an information handling device of the communication system of FIG. 1 in accordance with the embodiment of the present invention;

FIG. 3 illustrates a dongle of the communication system of FIG. 1 in accordance with the embodiment of the present invention;

FIG. 4 illustrates a block diagram of the dongle of FIG. 3 in accordance with the embodiment of the present invention;

FIG. 5 illustrates a block diagram of the information handling device of FIG. 2 in accordance with the embodiment of the present invention;

FIG. 6 illustrates a block diagram of a communication system of a vehicle of the communication system of FIG. 1 in accordance with the embodiment of the present invention;

FIG. 7 illustrates a flowchart of the operation of the dongle controller of FIG. 4 in accordance with the embodiment of the present invention;

FIG. 8 illustrates a flowchart of the operation of the controller of the information handling device of FIG. 5 in accordance with the embodiment of the present invention; and

FIG. 9 illustrates a flowchart of the operation of the communication controller of the vehicle of FIG. 6 in accordance with the embodiment of the present invention.

### DESCRIPTION OF AN EXEMPLARY EMBODIMENT

The following detailed description is merely exemplary in nature and is not intended to limit the invention or the application and uses of the invention. Furthermore, there is no intention to be bound by any expressed or implied theory presented in the preceding technical field, background, brief summary or the following detailed description.

Referring to FIG. 1, a communication system 100 for local area wireless communication, such as radio frequency (RF) WiFi communication, includes a wireless access point 102 having a computer 104 or other information handling device (e.g., a personal digital assistant (PDA)) with wireless transceiving capability coupled thereto. The computer 104 wirelessly communicates with a vehicle 106 via an antenna 108 coupled to the wireless access point 102 and an antenna 110 coupled to the vehicle 106. While the communication system 100 communicates via a RF wireless link. Those skilled in the art will realize that any wireless link such as an infrared or other wireless link could be utilized in accordance with the present embodiment. Further, while the computer 104 is coupled to the wireless access point 102 for wireless communication via the antenna 108, those skilled in the art will also realize that the computer 104 could wirelessly communicate with the vehicle 106 via a wireless adapter coupled to and/or incorporated with the computer 104.

In accordance with the present embodiment, when the vehicle 102 is present within a coverage area 112 encompassing, for example, a garage or driveway, the computer 104 can communicate with the vehicle 106 for downloading personalized media (e.g., songs stored as MPEG audio files or navigational data) for utilization by the driver of the vehicle 106 during operation thereof. In this manner media, such as song data or navigational data, can be transferred from the computer 104 via the wireless access point 102 to the vehicle 106 within the coverage area 112.

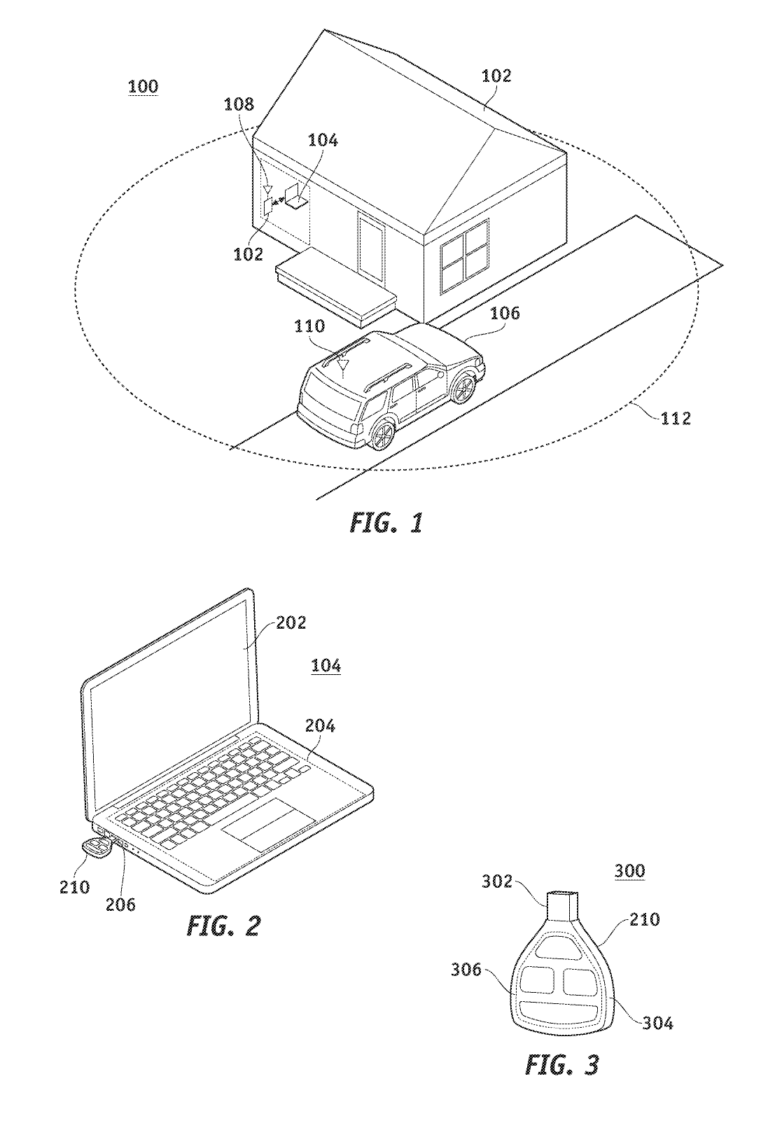

Since an engine of the vehicle 106 is typically not running when the vehicle 106 is parked in the driveway or garage within the coverage area 112, the present embodiment provides a method and means for enabling communications between the computer 104 and the vehicle 106 wherein the computer 104 can “wakeup” communication portions of the vehicle 106 for such communications. Referring to FIG. 2, the computer 104 includes user interface devices such as a display 202 and user input devices 204. The computer 104 also includes a Universal Serial Bus (USB) port 206. In accordance with the present embodiment, a dongle 210 can be coupled to the computer 104 via the USB port 206. Those skilled in the art will realize that other ports and or other coupling schemes could be utilized for coupling the dongle 210 to the computer 104 for communication therewith.

In accordance with the present embodiment, the dongle 210 provides the means for enabling communications between the computer 104 and the vehicle 106. Referring to FIG. 3, a view 300 of the dongle 210 depicts the USB plug 302. The remainder of the dongle is a key fob 304 for remote keyless entry communication with the vehicle 106 and includes user input buttons 306 for vehicle door lock, unlock and trunk open functions as well as other key fob functions. While the dongle 210 is depicted as the key fob 210 in FIG. 3, in accordance with the present embodiment the dongle 210 could be a dedicated device with or without the user buttons 306 to enable communications with the vehicle 106 and includes an external coupling device, such as the USB plug 302, for coupling to the computer 104.

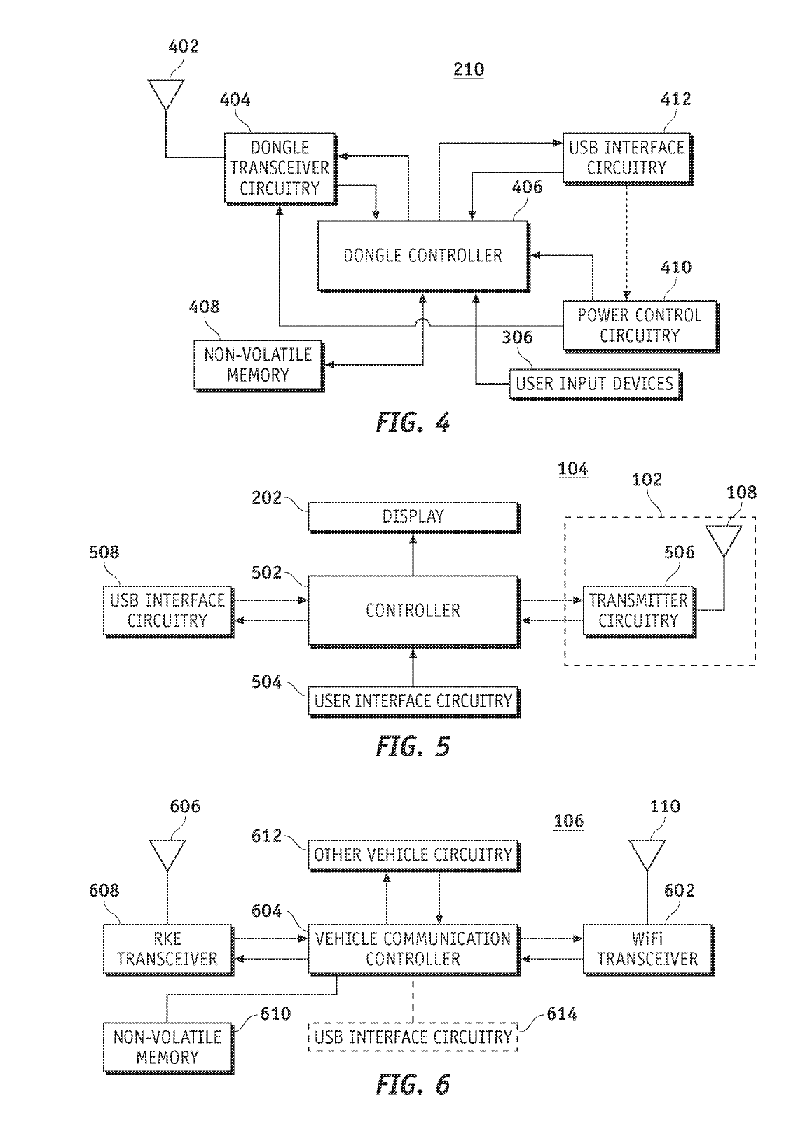

A block diagram of the dongle 210 is depicted in FIG. 4. The dongle 210 includes an antenna 402 and transceiver circuitry 404 for remote keyless communication with the vehicle 106. While typically remote keyless communication is one-way limited distance communication between the key fob 304 and the vehicle 106, recent key fob structures include two-way transceiving capability for increased key fob functionality. In accordance with the present embodiment, therefore, the transceiver circuitry 404 could comprise either transmitter circuitry only or both receiver and transmitter circuitry. The transceiver circuitry 404 is coupled to a dongle controller 406 for receiving signals therefrom for transmission from the antenna 402 and for providing signals received by the antenna 402 and demodulated by the transceiver circuitry 404 to the dongle controller 406.

The dongle 210 also includes a non-volatile memory 408 for storage of information for remote keyless operation of the dongle controller 406 as well as other information necessary to initiate the wireless link between the computer 104 and the vehicle 106. Power control circuitry 410 controls power for operation of the transceiver circuitry 404 and the dongle controller 406. In accordance with the present embodiment, external device coupling circuitry, such as USB interface circuitry 412, is provided for communication with the computer 104. The USB interface circuitry 412 provides signals received thereby to the dongle controller 406 and also provides signals received from the dongle controller 406 to an external device such as the computer 104 or the vehicle 106 when coupled thereto. The power control circuitry 410 may receive power for operation of the dongle 210 form the USB interface circuitry 410 when the dongle is coupled to the computer 104 or the vehicle 106. Alternatively, a battery (not shown) may be coupled to the power control circuitry 410 for operation of the dongle 210, such as operation of conventional key fob functions.

A simplified block diagram of the computer 104 and the wireless access point 102 is presented in FIG. 5. The computer 104 includes the display 202 for presenting information to a user in response to signals received from a microprocessor controller 502. In addition, user interface circuitry 504, including the user input devices 204 (FIG. 2), receives user inputs and provides signals in response to the user inputs to the controller 502. In addition, USB interface circuitry 508 is also coupled to the controller 502 for providing signals from the controller to a device coupled to the USB port 206 of the computer 104 and for providing signals from the device coupled to the USB port 206 to the controller 502. In a manner well known to those skilled in the art, the wireless access point 102 includes transceiver circuitry 506 and the antenna 108. The transceiver circuitry 506 is coupled to the controller 502 of the computer 104 for local area RF communication, such as WiFi communication. As described above, the computer 104 could alternatively use transceiver circuitry incorporate therein for local area wireless communication such as RF WiFi communication.

Referring to FIG. 6, a simplified block diagram of a portion of the circuitry of the vehicle 106 which includes a communication system is depicted. The antenna 110 is coupled to WiFi transceiver circuitry 602 for enabling local area communication with a vehicle communication controller 604 of the vehicle 106. A second antenna 606 is coupled to remote keyless entry (RKE) transceiver circuitry 608 for enabling RKE communication with the vehicle communication controller 604.

A nonvolatile memory 610 is coupled to the vehicle communication controller 604 and stores information for the operation of the vehicle communication controller 604 in accordance with the present embodiment. The nonvolatile memory 610 also stores information received via the WiFi transceiver circuitry 602 for later provision by the vehicle communication controller 604 to other vehicle circuitry 612 such as a digital audio player or a navigational device.

In accordance with the present embodiment, the vehicle communication controller 604 couples to the dongle 210 via the antenna 606 and the RKE transceiver 608. In addition, a USB port and USB interface circuitry 614 could optionally be provided in the vehicle 106 for physically and electrically coupling the dongle 210 to the vehicle communication controller 604 for operation in accordance with the present embodiment.

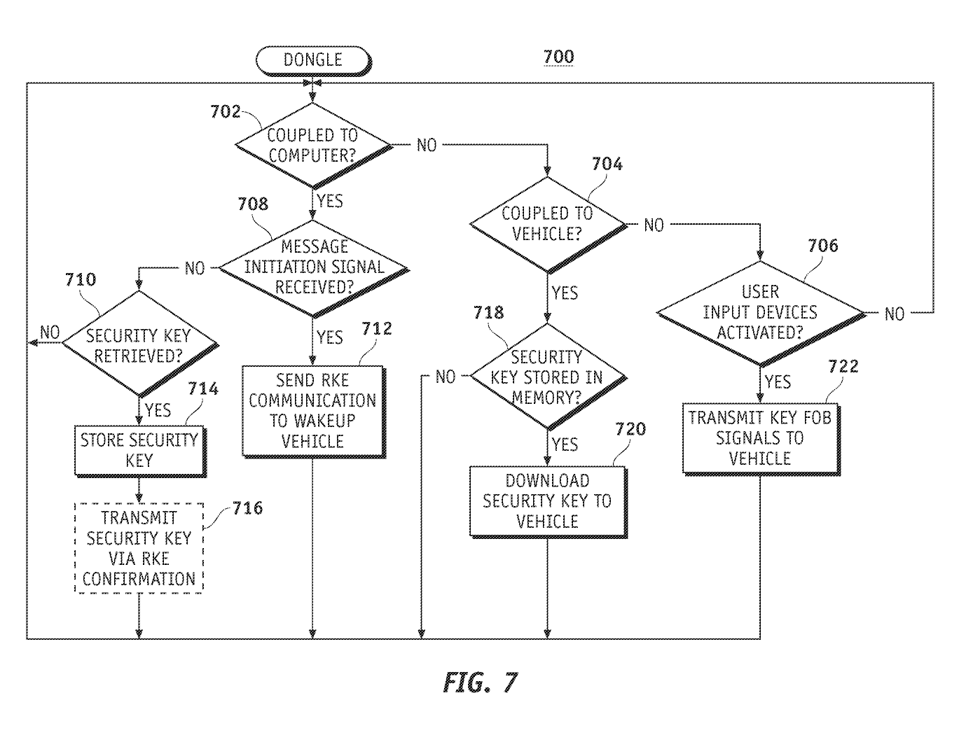

Referring to FIG. 7, a flowchart 700 depicts operation of the dongle controller 406 in accordance with the present embodiment. Initially, the dongle controller 406 awaits detection 702 of the dongle 210 being coupled to the computer 104, detection 704 of the dongle 210 being coupled to the vehicle 106, or activation 706 of one or more of the user input devices 306.

When the dongle controller 406 detects 702 that the dongle 210 is coupled to the computer 104, the dongle controller 406 determines whether a message initiation signal has been received 708 from the computer 104 or whether a security key for protection of communication on the local area wireless link has been received 710 from the computer 104. When the dongle controller 406 determines that a message initiation signal has been received 708, the dongle controller 406 provides 712 a remote keyless entry (RKE) wakeup message to the dongle transceiver circuitry 404 for transmission to the vehicle 106. Processing then returns to await detection 702 of the dongle 210 being coupled to the computer 104, detection 704 of the dongle 210 being coupled to the vehicle 106, or activation 706 of one or more of the user input devices 306.

When the dongle controller 406 determines that the security key has been received 710, the dongle controller 406 stores 714 the security key in the memory 408. The security key is utilized for authentication of communication between the vehicle 106 and the computer 104 as described hereinbelow. After storing 714 the security key, the dongle controller 406 may transmit 716 the security key via RKE communication to the vehicle communication controller 604 or may maintain the security key in the memory 408 for later transfer to the vehicle communication controller 604. After storing the security key at step 714 and, possibly, transmitting the security key at step 716, processing returns to decision steps 702, 704 and 706.

In accordance with one aspect of the present embodiment, the dongle 210 can be electrically and physically coupled to the vehicle 106 by coupling to the vehicle controller 604 via the USB interface circuitry 614. When the dongle controller 406 determines 704 that the dongle is coupled to the vehicle (i.e., coupled to the USB interface circuitry 614), the dongle controller 406 determines 718 whether the security key is stored in the memory 408. If the dongle controller 406 determines 718 that the security key is stored in the memory 408, the dongle controller 406 cooperates with the vehicle communication controller 604 to download 720 the security key from the memory 408 to the memory 610. After download of the security key 720 or if the dongle controller 406 determines 718 that the security key is not stored in the memory 408, processing will return to await detection 702 of the dongle 210 being coupled to the computer 104, a subsequent detection 704 of the dongle 210 being coupled to the vehicle 106, or activation 706 of one or more of the user input devices 306.

When one or more of the user input devices 306 are activated 706, user key fob input signals are received by the dongle controller 406 and the dongle controller provides 722 signals to the transceiver circuitry 404 for transmission to the vehicle 106 via RKE transmission for activation of vehicle key fob functions in a manner well-known to those skilled in the art. After provision of the signals for transmission 722 or when no user input devices 306 are activated 706, processing returns to decision steps 702, 704 and 706.

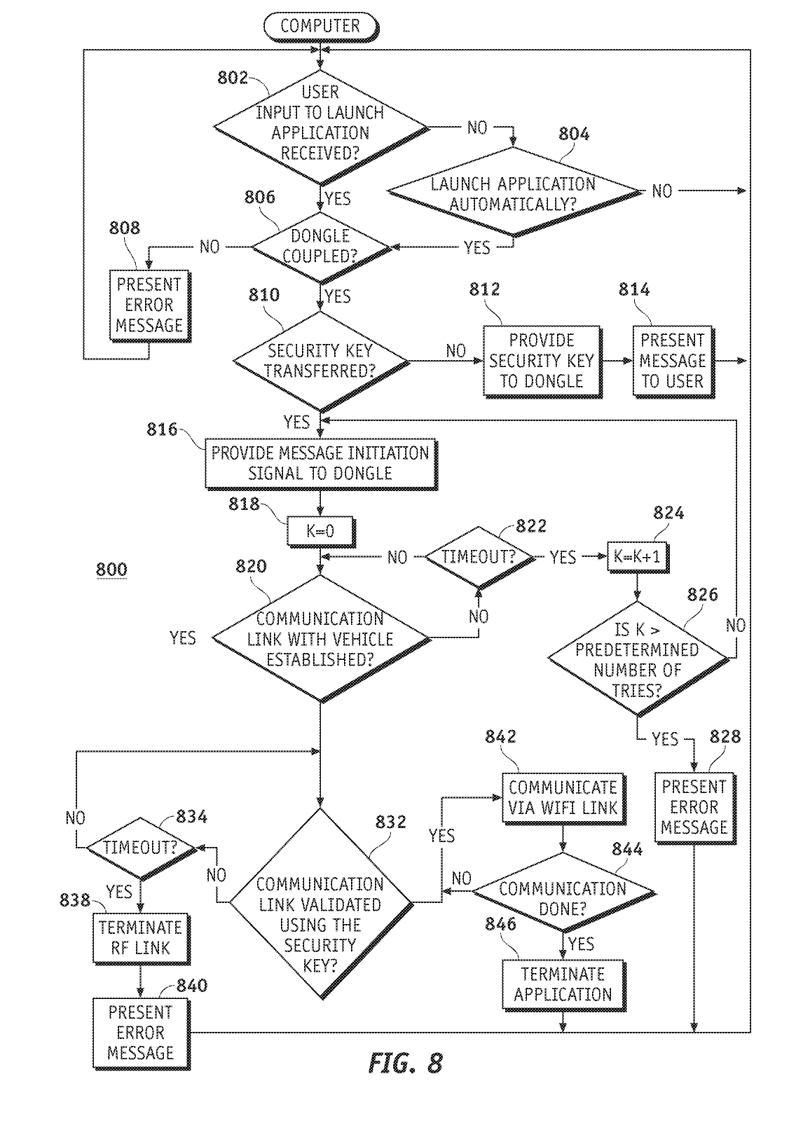

Referring to FIG. 8, a flowchart 800 depicts operation of the computer controller 502 in accordance with the present embodiment. While the microprocessor controller 502 can perform a large variety of functions, in accordance with the present embodiment, the microprocessor controller 502 awaits detection 802 of a user input from the user interface circuitry 506 indicating a request to launch a local area communication application for communicating information (such as uploading media) between the information handling device 104 and the vehicle 106. If no user input is detected 802 by the microprocessor controller 502, the controller 502 next determines 804 whether the local area communication application is to be automatically launched in response to parameters monitored by the controller 502 (e.g., whether a timer (not shown) indicates a predetermined time for automatically launching the application, or whether the controller 502 detects that the dongle 210 has been coupled to the USB interface circuitry 508 and such detection is a parameter which causes the controller 502 to automatically launch the application). If no user input indicating manual launching of the local area communication application is detected 802 and no monitored parameter indicating automatic launching of the local area communication application is detected 804, processing will await detection of one or the other application launch indication 802, 804 before the microprocessor controller 502 begins operation in accordance with the present embodiment.

When a user input indicating manual launching of the local area communication application is detected 802 or a monitored parameter indicating automatic launching of the local area communication application is detected 804, the microprocessor controller 502 determines 806 whether the dongle 210 is coupled to the computer 104. If the dongle 210 is not coupled 806 to the computer 104, the controller 502 will provide appropriate signals to the user interface circuitry 504 to present a predetermined error message to the user and processing will return to await a positive decision to either step 802 or 804 and a positive decision to step 806.

As described hereinabove, the security key can be manually transferred to the vehicle 106 by the user carrying the dongle 210 to the vehicle 106 and coupling it thereto or, if the dongle 210 has the ability for transmitting signals from which the security key is recoverable, the dongle 210 can transmit the security key via remote keyless entry communication signals to the vehicle 106. Thus, when the dongle 210 is coupled 806 to the computer 104, the microprocessor controller 502 determines 810 whether a security key has been transferred to the dongle 210 by either querying the dongle 210 or checking records maintained by the computer 104. If the security key has not been transferred 810 to the dongle 210, the controller 502 provides 812 the security to the dongle 210 via the USB interface circuitry 508 and provides 814 appropriate signals to the user interface circuitry 504 to present a message to the user that the security key needs to be transferred to the vehicle 106 before the application can be launched. Processing then returns to steps 802, 804 and 806.

When the dongle 210 is coupled 806 to the computer 104 and the security key has been transferred 810, a message initiation signal is provided 816 from the controller 502 to the dongle 210 via the USB interface circuitry 508 and a communication attempt counter K is initialized to zero 818. The microprocessor controller 502 then determines 820 whether the vehicle has established a predetermined local area RF link with the computer 104 within a timeout period 822 by, for example, the reception of a probe request from the vehicle 106 and the computer responding to such probe request to establish the connection. If the timeout period expires 822 without the predetermined local area RF link being established 820, the communication attempt counter K is incremented 824 by one and the controller 502 determines 826 whether the value of the communication attempt counter K is greater than the predetermined number of permitted communication attempts, a parameter set by the local area communication application or by the user through the local area communication application. If the communication attempt counter K is incremented 824 and its value is not greater than the predetermined number of permitted communication attempts 826, the controller 502 resends 816 the message initiation signal to the dongle 210 and awaits establishment of the predetermined local area RF link 820. If the communication attempt counter K is incremented 824 and its value is greater than the predetermined number of permitted communication attempts 826, the controller 502 provides 828 appropriate signals to the user interface circuitry 504 to present a message to the user that the computer 104 has been unable to establish the predetermined local area RF link with the vehicle 106. Processing then returns to await subsequent manual 802 or automatic 804 launching of the local area communication application and determination 806 of the dongle 210 being coupled to the computer 104.

When the predetermined local area RF link is established 820 with the vehicle 106, the controller 502 determines 832, utilizing the pre-established security key, whether the communication link is validated or authenticated in accordance with any type of authentication scheme. If the communication link is not authenticated 832 within a predetermined timeout period 834, the controller 502 terminates the local area communication 838 and provides 840 appropriate signals to the user interface circuitry 504 to present a message to the user that the predetermined local area RF link with the vehicle 106 has not been authenticated. Processing then returns to await subsequent manual 802 or automatic 804 launching of the local area communication application and determination 806 of the dongle 210 being coupled to the computer 104.

If the authentication scheme is successful 832 within the timeout period 834, the controller 502 communicates 842 with the vehicle 106 via the predetermined local area RF link and downloads media to the vehicle 106 as instructed until the communication is ended 844. The application is then terminated 846 which may include, for example, presentation of a message to the user via the user interface circuitry 504, that the media or other information has been downloaded to the vehicle 106. Processing then returns to await subsequent manual 802 or automatic 804 launching of the local area communication application and determination 806 of the dongle 210 being coupled to the computer 104.

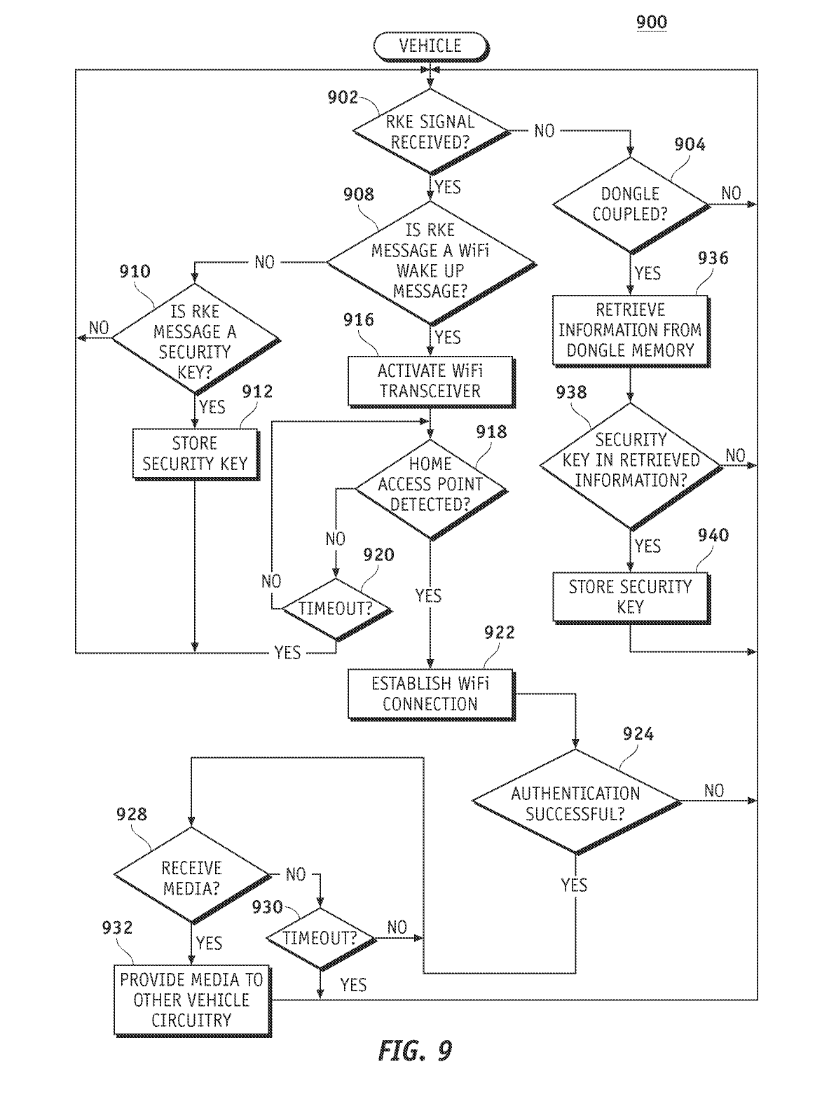

Referring to FIG. 9, a flowchart 900 depicts operation of the vehicle communication controller 604 in accordance with the present embodiment. Processing by the vehicle communication controller 604 initially awaits reception 902 of RKE signals from the RKE transceiver 608 or detection of coupling 904 of the dongle 210 to the vehicle communication controller 604 via the USB interface circuitry 614.

When RKE signals are received 902 from the RKE transceiver 608, the vehicle communication controller 604 determines 908 whether the message is a WiFi wakeup message 908 or whether a security key has been received 910. If neither a WiFi wakeup message nor a security key has been received 908, 910, processing returns to await subsequent reception 902 of RKE signals or detection of coupling 904 of the dongle 210. When a security key is received 910, the vehicle communication controller 604 stores 912 the security key in the memory 610. Processing then returns to await subsequent reception 902 of RKE signals or detection of coupling 904 of the dongle 210.

When the communication controller 604 determines that a WiFi wakeup message has been received 908, the communication controller 604 activates the WiFi transceiver 916 and determines 918 whether the computer 104 has been detected at the home access point 102 within a timeout period 920. This detection 918 could be accomplished by transmitting a probe request on the predetermined WiFi link and awaiting a response from the computer 104 or by monitoring the predetermined WiFi link to detect a beacon of the home access point 102, such as detecting an SSID of the home access point 102 on the predetermined WiFi link. If the computer 104 has not been detected 918 at the home access point 102 within the timeout period 920, processing returns to await subsequent reception 902 of RKE signals or detection of coupling 904 of the dongle 210.

If the computer 104 is detected 918 at the home access point 102 within the timeout period 920, a WiFi link is established 922 with the computer 104 and the controller 604 determines 924 whether authentication of the WiFi communication link with the computer 104 is successful within, for example, a predetermined time after WiFi communication has been established 922. If authentication is successful 924, the vehicle communication controller 604 then awaits reception 928 of media from the computer 104 within a timeout period 930. If no media is received 928 within the timeout period 930, processing returns to await reception 902 of RKE signals or detection of coupling 904 of the dongle 210. When media is received 928, the media (e.g., audio or navigational data) is provided 932 to the other vehicle circuitry 612 (e.g., digital audio system or navigational device) for utilization thereby. Processing then returns to await reception 902 of RKE signals or detection of coupling 904 of the dongle 210.

When the vehicle communication controller 604 determines 904 that the dongle 210 is coupled to the vehicle 106, the vehicle communication controller 604 establishes 936 communication with the dongle 210. When the vehicle communication controller 604 retrieves 938 the security key from the dongle 210, the security key is stored 940 in the memory 610 and processing returns to await subsequent reception 902 of RKE signals or subsequent detection of coupling 904 of the dongle 210. If the vehicle communication controller 604 is unable to retrieve 938 the security key (e.g., no security key is stored in the dongle memory 408), processing will return to await reception 902 of RKE signals or subsequent detection of coupling 904 of the dongle 210.

Thus it can be seen that methods and apparatus have been provided for facilitating a secure setup of a RF interface for home-to-vehicle applications while preserving the vehicle battery and enabling the vehicle to respond to remote requests when the vehicle ignition is OFF. While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should be understood that various changes can be made in the function and arrangement of elements without departing from the scope of the invention as set forth in the appended claims and the legal equivalents thereof.

What is claimed is:

1. A method for enabling communication between an information handling device and a vehicle, the method comprising the steps of:
launching a local area communication application for communicating information between the information handling device and the vehicle via a predetermined local area wireless link;
providing a communication initiation signal to a dongle connected to the information handling device for signaling the vehicle to establish the predetermined local area wireless link with the information handling device; and
thereafter, communicating with the vehicle in response to the vehicle establishing the predetermined local area wireless link.

2. The method in accordance with claim 1 wherein the step of providing the communication initiation signal comprises the step of
providing the communication initiation signal to the dongle coupled to the information handling device to transmit a remote keyless entry wakeup message to the vehicle.

3. The method in accordance with claim 1 wherein the step of providing the communication initiation signal comprises the steps of:
determining if the dongle is coupled to the information handling device; and
providing the communication initiation signal to the dongle in response to determining that the dongle is coupled to the information handling device.

4. The method in accordance with claim 1 wherein the predetermined local area wireless link comprises a radio frequency (RF) link, and wherein the step of communicating with the vehicle comprises the step of communicating with the vehicle via the RF link established by the vehicle with the information handling device.

5. The method in accordance with claim 1 wherein the step of launching the local area communication application comprises the step of launching the local area communication application in response to detecting a predetermined user application initiation input.

6. The method in accordance with claim 1 further comprising the step of providing a security key to the dongle in response to detecting coupling of the dongle to the information handling device.

7. The method in accordance with claim 1 wherein the step of communicating with the vehicle comprises the step of initiating secure communication with the vehicle over the predetermined local area wireless link.

8. The method in accordance with claim 7 wherein the step of initiating secure communication with the vehicle comprises the steps of:
determining whether a security key has been received from the vehicle; and
initiating secure communication over the predetermined local area wireless link in response to determining that the security key is an authentic security key.

9. The method in accordance with claim 1 wherein the step of communicating with the vehicle comprises the step of transferring media data to the vehicle over the predetermined local area wireless link.

10. A dongle for enabling communication between a vehicle and an information handling device, the dongle comprising:
an external coupling device for coupling to the information handling device;
dongle transceiver circuitry for remote keyless entry communication with the vehicle; and
a dongle controller coupled to the external coupling device for determining when the dongle is coupled to the information handling device, wherein the dongle controller is further coupled to the dongle transceiver circuitry for providing a remote keyless entry wakeup message to the dongle transceiver circuitry in response to receiving a communication initiation signal from the information handling device.

11. The dongle in accordance with claim 10 further comprising user input devices for generating user key fob input signals in response to activation of the user input devices, wherein the dongle controller provides signals to the vehicle via the transceiver circuitry for vehicle key fob functions in response to the user key fob input signals.

12. The dongle in accordance with claim 10 further comprising a nonvolatile storage device, wherein the dongle controller provides a security key to the nonvolatile storage device for storage therein in response to detecting reception of the security key from the information handling device via the external coupling device.

13. The dongle in accordance with claim 12 wherein the dongle controller provides the security key for download to a vehicle memory in response to determining that the security key is stored in the nonvolatile storage device and that the external coupling device is coupled to a vehicle port.

14. The dongle in accordance with claim 12 wherein the dongle controller provides signals to the remote keyless entry transceiver circuitry for remote keyless entry transmission of the security key to the vehicle in response to determining that the security key is stored in the nonvolatile storage device and establishing a remote keyless entry communication link with the vehicle.

15. The dongle in accordance with claim 10 wherein the external coupling device comprises a Universal Serial Bus (USB) plug.

16. A communication system in a vehicle for communicating with an information handling device at a wireless access point, the system comprising:
first wireless transceiver circuitry for communicating with the information handling device via a predetermined local area wireless link;
second wireless transceiver circuitry for communicating with a dongle via a remote keyless entry communication link; and
a communication controller coupled to the first and second wireless transceiver circuitries and for activating the first wireless transceiver circuitry for communicating via the predetermined local area wireless link with the information handling device at the wireless access point in response to detecting reception of a remote keyless entry wakeup message received by the second wireless transceiver circuitry.

17. The system in accordance with claim 16 further comprising a nonvolatile memory coupled to the communication controller for storing a security key therein, the communication controller retrieving the security key from the nonvolatile memory and transmitting the security key to the wireless access point via the first wireless transceiver circuitry to establish communication with the information handling device at the wireless access point.

18. The system in accordance with claim 17 further comprising a vehicle port for physically coupling to a dongle and for electrically coupling the dongle to the communication controller, wherein the communication controller receives the security key from the dongle while the dongle is coupled to the vehicle port.

19. The system in accordance with claim 17 wherein the communication controller receives the security key within a remote keyless entry message received via the second wireless transceiver circuitry, the communication controller storing the security key in the nonvolatile memory upon reception thereof.

20. The system in accordance with claim 16 wherein the first wireless transceiver circuitry comprises local area wireless transceiver circuitry for WiFi communication with the information handling device at the wireless access point via a WiFi radio frequency (RF) link.
